(19) United States
(12) Patent Application Publication
(10) Pub. No.: US 2022/0094435 A1
(43) Pub. Date: Mar. 24, 2022

(54) VISIBLE LIGHT COMMUNICATION APPARATUS, VISIBLE LIGHT COMMUNICATION METHOD, AND VISIBLE LIGHT COMMUNICATION PROGRAM

(71) Applicant: SONY GROUP CORPORATION, TOKYO (JP)

(72) Inventors: KEITARO YAMAMOTO, TOKYO (JP); RYUTA SATOH, TOKYO (JP)

(21) Appl. No.: 17/424,203

(22) PCT Filed: Jan. 20, 2020
(86) PCT No.: PCT/JP2020/001773

§ 371 Date: Jul. 20, 2021

(30) Foreign Application Priority Data
Jan. 28, 2019 (JP) 2019-012480

(51) Int. Cl. H04B 10/116; G08G 1/16; G08G 1/09; G06V 20/58

(52) U.S. Cl. CPC H04B 10/116; G08G 1/16; H04W 4/40; G06V 20/584; G08G 1/091

(57) ABSTRACT

A visible light communication apparatus according to the present disclosure includes an acquisition section configured to acquire an image captured by a sensor included in a mobile object, a first extraction section configured to detect an object included in the image and extract a first region that includes the object, a second extraction section configured to detect a light source from inside the first region and extract a second region that includes the light source, and a visible light communication section configured to perform visible light communication with the light source included in the second region.

### TECHNICAL FIELD

The present disclosure relates to a visible light communication apparatus, a visible light communication method, and a visible light communication program. More particularly, the present disclosure relates to a visible light communication technology using RoI (Region of Interest) processing.

### BACKGROUND ART

Studies have been made regarding visible light communication which is a type of wireless communication using electromagnetic waves in visible light bands, with a view to commercial applications in a variety of fields.

As techniques related to the visible light communication, there are known visible light communication techniques for adjusting the exposure time of a sensor to enable communication with various types of information devices (e.g., see PTL 1). There are also known techniques for improving the sampling rate at which the blinking of a light source is measured, by use of line scan characteristics of a CMOS image sensor (Complementary Metal-Oxide Semiconductor image sensor) (see NPL 1, for example).

### CITATION LIST

### Patent Literature

[PTL 1]

PCT Patent Publication No. WO2014/103341

### Non Patent Literature

[NPL 1]

“Image Sensor-based Visible Light Communication Technology,” Panasonic Technical Journal Vol. 61, No. 2, November 2015

### SUMMARY

### Technical Problem

The existing technology enables various types of information devices to provide visible light communication and to increase the amount of information in visible light communication.

However, according to the above-mentioned existing technology, it is difficult for a mobile object to conduct visible light communication stably. For example, the existing visible light communication involves observing light sources found in images captured by sensors (e.g., cameras). For that reason, in a case where multiple light sources are found in the image or where a light source or a sensor moves, stable visible light communication may not be available.

Under such circumstances, the present disclosure proposes a visible light communication apparatus, a visible light communication method, and a visible light communication program for enabling a mobile object to conduct visible light communication stably.

### Solution to Problem

In order to solve the above problem, according to an aspect of the present disclosure, there is provided a visible light communication apparatus including an acquisition section configured to acquire an image captured by a sensor included in a mobile object, a first extraction section configured to detect an object included in the image and extract a first region that includes the object, a second extraction section configured to detect a light source from inside the first region and extract a second region that includes the light source, and a visible light communication section configured to perform visible light communication with the light source included in the second region.

### BRIEF DESCRIPTION OF DRAWINGS

FIG. 1 is a diagram that outlines information processing according to one embodiment of the present disclosure.

FIG. 2 is a diagram depicting a configuration example of a visible light communication apparatus according to the embodiment of the present disclosure.

FIG. 3 is a diagram (1) for explaining an object recognition process according to the embodiment of the present disclosure.

FIG. 4 is a diagram (2) for explaining the object recognition process according to the embodiment of the present disclosure.

FIG. 5 depicts diagrams (3) for explaining the object recognition process according to the embodiment of the present disclosure.

FIG. 6 depicts diagrams (4) for explaining the object recognition process according to the embodiment of the present disclosure.

FIG. 7 is a flowchart (1) depicting a process flow according to the embodiment of the present disclosure.

FIG. 8 is a flowchart (2) depicting a process flow according to the embodiment of the present disclosure.

FIG. 9 is a flowchart (3) depicting a process flow according to the embodiment of the present disclosure.

FIG. 10 is a diagram for explaining visible light communication processing according to a modification of the present disclosure.

FIG. 11 is a diagram for explaining a transmission/reception process in visible light communication.

FIG. 12 is a block diagram depicting a schematic functional configuration example of a mobile object control system to which the present technology is applicable.

FIG. 13 is a hardware configuration diagram depicting an example of a computer for implementing the functions of the visible light communication apparatus.

### DESCRIPTION OF EMBODIMENTS

Some preferred embodiments of the present disclosure are described below in detail with reference to the accompanying drawings. It is to be noted that, throughout the following description of the embodiments, identical parts are denoted by identical reference signs, and redundant explanations are omitted.

The present disclosure is explained in the

1. Embodiment
1-1. Overview of information processing according to embodiment
1-2. Configuration of visible light communication apparatus according to embodiment
1-3. Information processing procedure according to embodiment
1-4. Modifications of embodiment

2. Other embodiments
2-1. Different processes with different number of cameras
2-2. Transmission/reception process in visible light communication

12-3. Configuration of mobile object
2-4. Others

3. Effects of visible light communication apparatus according to present disclosure

4. Hardware configuration

### 1. Embodiment

### [1-1. Overview of Information Processing According to Embodiment]

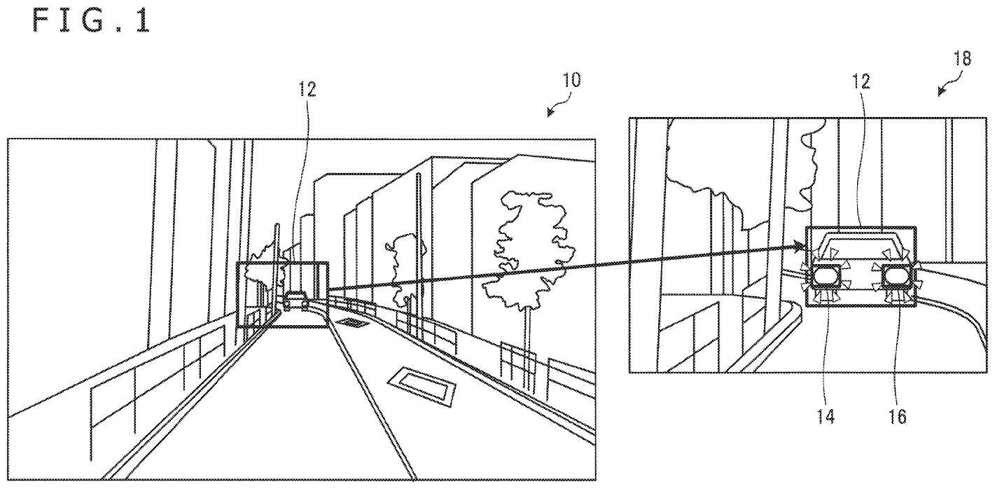

FIG. 1 is a diagram that outlines information processing according to one embodiment of the present disclosure. The information processing according to the embodiment of the present disclosure relates to visible light communication conducted by means of sensors (e.g., camera) included in a predetermined mobile object, for example.

In the embodiment, description is given by using a vehicle as a typical mobile object. That is, the information processing according to the embodiment is performed by a visible light communication apparatus 100 (not depicted in FIG. 1) mounted on the vehicle.

The visible light communication apparatus 100 observes the surrounding status and detects light sources in the surroundings by using cameras mounted on the vehicle. The visible light communication apparatus 100 then performs visible light communication with the detected light source. It should be noted that the camera included in the visible light communication apparatus 100 acquires pixel information indicative of the surrounding status by using a CMOS image sensor, for example.

Generally, the mobile object such as the vehicle can acquire various types of information by conducting visible light communication by use of light sources such as a vehicle ahead, traffic lights, and road studs. Specifically, the mobile object acquires the speed of the vehicle ahead and an inter-vehicle distance thereto on the basis of the visible light sent therefrom by way of brake lights and tail lights, for example. Such communication between the mobile objects is referred to as vehicle-to-vehicle communication, for example. Further, on the basis of the information sent from the traffic lights and road studs, the mobile object acquires, for example, the presence of a vehicle approaching from a blind angle relative to the own vehicle and the status of pedestrians on the crossing. Such communication between the mobile object and the objects set up on the road is referred to as road-to-vehicle communication, for example. The road-to-vehicle communication includes exchanges of information regarding traffic accidents and congestions on the road ahead as well as information regarding the road surface status.

As described above, the visible light communication by the mobile object permits transmission and reception of various types of information. Such communication thus contributes advantageously to automated driving of the mobile object, for example.

However, since the visible light communication involves observing the light sources included in the whole image captured by the mobile object, stable visible light communication may not be possible in a case where multiple light sources are found in the image or where a light source or a sensor moves, for example.

Under such circumstances, the visible light communication apparatus 100 according to the present disclosure enables the mobile object to conduct stable visible light communication, by performing information processing to be described later. Specifically, the visible light communication apparatus 100 performs RoI (Region of Interest) processing on a captured image on the assumption that the captured image includes multiple light sources. For example, the visible light communication apparatus 100 images the surroundings to acquire an image of the surroundings and detects target objects by performing an image recognition process on the acquired image. For example, the visible light communication apparatus 100 detects previously learned objects in the image by using a learner trained by use of CNN (Convolutional Neural Network) or the like. For example, the visible light communication apparatus 100 can accurately detect objects by using filters of different sizes (e.g., 5×5 pixels or 10×10 pixels) in sequence on a single-frame image. It should be noted that the target objects to be detected are the objects with which the vehicle is to avoid collision and the objects that the vehicle should recognize, such as pedestrians, bicycles, other vehicles, traffic lights, traffic signs, and road studs.

Further, the visible light communication apparatus 100 detects, from a region including the detected objects (the region may hereinafter be referred to as a “first region”), a region including light sources (the region may hereinafter be referred to as a “second region”). In the embodiment, the light sources include traffic lights, road studs, and brake lights and tail lights of other vehicles, for example. The visible light communication apparatus 100 performs readout processing (RoI processing) not on the entire image but solely on the detected second region.

In such a manner, the visible light communication apparatus 100 does not detect light sources from the entire captured image. Instead, the visible light communication apparatus 100 first detects objects and then detects light sources on or near the detected objects. The visible light communication apparatus 100 further performs readout processing on the second regions near the detected light sources, thereby conducting visible light communication at high speed in such a manner as to ensure a sufficient amount of information. Even in a case where the visible light communication apparatus 100 itself or some other mobile object moves, the visible light communication apparatus 100 maintains the communication by keeping track of the detected second regions (tracking). That is, even in a case where the image includes multiple light sources, the visible light communication apparatus 100 can conduct stable visible light communication.

With reference to FIG. 1, an overview of the information processing according to the embodiment of the present disclosure is described below. An image 10 depicted in FIG. 1 is captured by a camera included in the visible light communication apparatus 100. The visible light communication apparatus 100 captures the image 10 and also detects objects included in the image 10. The process of detecting the objects is performed by use of a previously trained learner, for example. It should be noted that the object detection process may involve any suitable known techniques such as an ADAS system (Advanced Driver Assistance System).

In the example of FIG. 1, the visible light communication apparatus 100 detects a vehicle ahead as the object and extracts, from the image 10, a first region 12 that includes the vehicle ahead.

An enlarged image 18 depicted in FIG. 1 indicates the surroundings of the first region 12. After extracting the first region 12, the visible light communication apparatus 100 detects light sources included in the first region 12. In the example of FIG. 1, the visible light communication apparatus 100 detects the tail lights of the vehicle ahead as the light sources. The visible light communication apparatus 100 further detects second regions 14 and 16 including the tail lights. It should be noted that FIG. 1 indicates the enlarged image 18 for purpose of explanation, but in practice the visible light communication apparatus 100 extracts the second regions 14 and 16 from the image 10.

The visible light communication apparatus 100 conducts visible light communication with the vehicle ahead by performing readout processing on the extracted second regions 14 and 16. That is, the visible light communication apparatus 100 sets the second regions 14 and 16 in the entire image 10 as the readout targets through RoI processing and carries out readout processing solely on the second regions 14 and 16. Specifically, the visible light communication apparatus 100 performs high-speed readout by skipping unnecessary lines by use of a parallel-type ADC (Analog to Digital Converter) CMOS image sensor for line-by-line readout. For example, if the number of lines (pixels) in a readout target region is one-third of the number of lines in the image 10, the visible light communication apparatus 100 can read the target regions three times as fast.

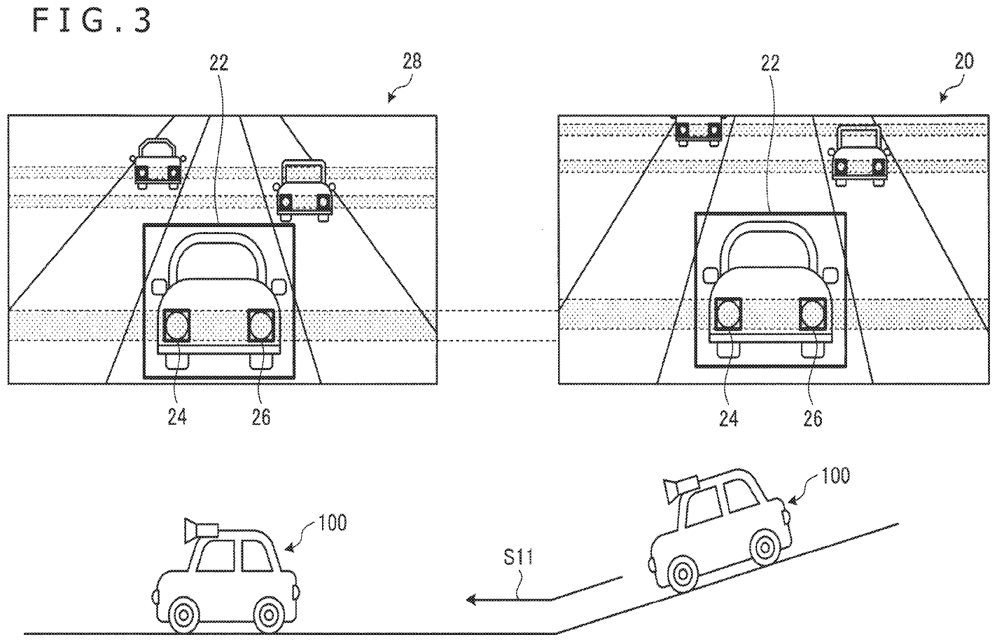

Further, the visible light communication apparatus 100 can simplify the process of tracking light sources by using not the whole image 10 but only the second regions 14 and 16 as the readout targets. For example, the visible light communication apparatus 100 can track the light sources without resorting to image processing at a reduced frame rate with respect to the RoI processing, such as rereading of the whole image 10. It should be noted that the light source tracking process will be described later in detail with reference to FIG. 3 and other drawings.

Thereafter, the visible light communication apparatus 100 performs visible light communication with the light sources included in the second regions 14 and 16. Specifically, the visible light communication apparatus 100 conducts visible light communication with the vehicle ahead at an amount of information corresponding to the frame rate and exposure time of the image sensor.

In such a manner, the visible light communication apparatus 100 acquires the image 10 captured by the camera included in the own apparatus, to detect objects (e.g., vehicle ahead) included in the image, and extracts the first region 12 that includes the objects. Also, the visible light communication apparatus 100 detects light sources from the first region 12 and extracts the second regions 14 and 16 that include the light sources. The visible light communication apparatus 100 then performs visible light communication with the light sources included in the second regions 14 and 16.

That is, the visible light communication apparatus 100 performs readout not on the entire image 10 but on the second regions 14 and 16 extracted through RoI processing, in carrying out visible light communication. This enables the visible light communication apparatus 100 to minimize the region from which the image to be used for communication is acquired, and to increase the frame rate for readout, so that the speed of visible light communication can be improved. Further, by minimizing the region from which the image to be used for communication is acquired, the visible light communication apparatus 100 can simplify the process of tracking the light sources. In such a manner, the visible light communication apparatus 100 can improve the efficiency of visible light communication by the mobile object and enable the mobile object to conduct stable visible light communication.

A configuration and the like of the visible light communication apparatus 100 that carries out the above-described information processing are described below in detail with reference to the accompanying drawings.

### [1-2. Configuration of Visible Light Communication Apparatus According to Embodiment]

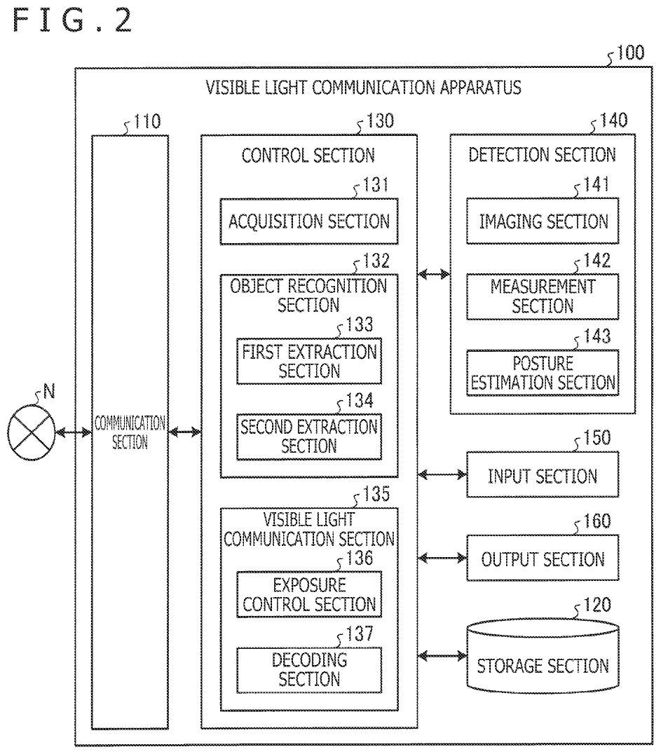

The configuration of the visible light communication apparatus 100 is explained with reference to FIG. 2. FIG. 2 is a diagram depicting a configuration example of the visible light communication apparatus 100 according to the embodiment of the present disclosure. As depicted in FIG. 2, the visible light communication apparatus 100 includes a communication section 110, a storage section 120, a control section 130, a detection section 140, an input section 150, and an output section 160. It is to be noted that the configuration depicted in FIG. 2 is a functional configuration and may differ from a hardware configuration. Also, the functions of the visible light communication apparatus 100 may be implemented by multiple apparatuses that are physically separated from each other, on a distributed basis.

The communication section 110 is implemented by using an NIC (Network Interface Card), for example. Alternatively, the communication section 110 may be a USB (Universal Serial Bus) interface configured with a USB host controller and a USB port. As another alternative, the communication section 110 may be a wired or wireless interface. For example, the communication section 110 may be a wireless communication interface based on a wireless LAN system or a cellular communication system. The communication section 110 functions as communication means or transmission means of the visible light communication apparatus 100. For example, the communication section 110 is connected to a network N (e.g., the Internet) in wired or wireless fashion and exchanges information with other information processing apparatuses over the network N.

The storage section 120 is implemented by using a semiconductor memory element such as a RAM (Random Access Memory) or a flash memory, or a storage apparatus such as a hard disk or optical disk, for example. The storage section 120 stores various types of data. For example, the storage section 120 stores a learner (e.g., image recognition model) having learned the target objects to be detected, as well as data regarding the detected objects. The storage section 120 may also function as a buffer memory for use in visible light communication. The storage section 120 may further store map data or the like for use in automated driving.

The detection section 140 detects various types of information regarding the visible light communication apparatus 100. Specifically, the detection section 140 detects information regarding the surrounding environment of the visible light communication apparatus 100, position information regarding the position of the visible light communication apparatus 100, information regarding the devices (light sources) conducting visible light communicating with the visible light communication apparatus 100, and other information. The detection section 140 may be replaced with sensors for detecting the various types of information. The detection section 140 according to the embodiment includes an imaging section 141, a measurement section 142, and a posture estimation section 143.

The imaging section 141 is a sensor device which has the function of capturing images of the surroundings of the visible light communication apparatus 100, and is what is called a camera. For example, the imaging section 141 is implemented by using a stereo camera, a monocular camera, a lens-less camera, or other cameras.

The measurement section 142 is a sensor that measures information regarding the visible light communication apparatus 100 and information regarding the vehicle on which the visible light communication apparatus 100 is mounted.

For example, the measurement section 142 is an acceleration sensor detecting the acceleration of the vehicle and a speed sensor detecting the speed of the vehicle.

The measurement section 142 may also measure the behavior of the vehicle on which the visible light communication apparatus 100 is mounted. For example, the measurement section 142 measures operated amounts of the brake pedal, accelerator pedal, and steering wheel of the vehicle. For example, by using respective sensors attached to the brake pedal, accelerator pedal, and steering wheel of the vehicle, the measurement section 142 measures the amounts representing the force (e.g., pressure) exerted on the brake pedal and the accelerator pedal. The measurement section 142 may also measure the speed and acceleration of the vehicle, amounts of acceleration and deceleration of the vehicle, yaw rate information of the vehicle, and the like. In measuring the information regarding such behavior of the vehicle, the measurement section 142 may use not only the above-mentioned sensors but also various known techniques.

The measurement section 142 may also include sensors for measuring distances to objects around the visible light communication apparatus 100. For example, the measurement section 142 may be a LiDAR (Light Detection and Ranging, Laser Imaging Detection and Ranging) for reading a three-dimensional structure of the surrounding environment of the visible light communication apparatus 100. The LiDAR detects the distance to an object in the surroundings and a relative speed with respect to the object, by measuring the period of time until laser light such as infrared laser returns upon reflection from the nearby object after being emitted thereto. Alternatively, the measurement section 142 may be a distance measurement system that uses millimeter-wave radar. The measurement section 142 may also include a depth sensor that acquires depth data.

The measurement section 142 may further include, for example, a microphone for collecting sounds around the visible light communication apparatus 100, an illuminance sensor for detecting the illuminance around the visible light communication apparatus 100, a humidity sensor for detecting the humidity around the visible light communication apparatus 100, and a geomagnetic sensor for detecting a magnetic field at the position of the visible light communication apparatus 100.

The posture estimation section 143 is, for example, what is called an IMU (Inertial Measurement Unit) for estimating the posture of the vehicle on which the visible light communication apparatus 100 is mounted. For example, an object recognition section 132 and a visible light communication section 135, which are to be described later, correct the effects of an inclination and behavior of the own vehicle on the captured image, on the basis of the information regarding the inclination and the behavior of the own vehicle that is detected by the posture estimation section 143.

The input section 150 is a processing section that accepts various operations from, for example, a user of the visible light communication apparatus 100. The input section 150 accepts input of various types of information via a keyboard or a touch panel, for example.

The output section 160 is a processing section that outputs various types of information. For example, the output section 160 may be a display and speakers. For example, the output section 160 displays an image captured by the imaging section 141 and displays the objects detected from inside the image, in the form of rectangles.

The control section 130 is implemented by using, for example, programs (e.g., visible light communication program according to the present disclosure) stored in the visible light communication apparatus 100 and executed by a CPU (Central Processing Unit), an MPU (Micro Processing Unit), or a GPU (Graphics Processing Unit) by using a RAM (Random Access Memory) as a work area. The control section 130 is also a controller and may be implemented by using an integrated circuit such as an ASIC (Application Specific Integrated Circuit) or a FPGA (Field Programmable Gate Array).

As depicted in FIG. 2, the control section 130 includes an acquisition section 131, an object recognition section 132, and a visible light communication section 135. The control section 130 implements or executes the functions and effects of the information processing to be described below. Incidentally, the internal configuration of the control section 130 is not limited to the configuration indicated in FIG. 2. The control section 130 may be configured otherwise as long as the control section 130 performs the information processing described below.

The acquisition section 131 acquires various types of information. For example, the acquisition section 131 acquires images captured by the sensor (imaging section 141) included in the mobile object on which the visible light communication apparatus 100 is mounted. For example, the acquisition section 131 acquires images captured by a stereo camera or a monocular camera (more specifically, an image sensor included in the stereo camera or monocular camera) serving as the sensor.

The acquisition section 131 further acquires pixel information regarding the captured image. For example, the acquisition section 131 acquires the luminance value of each of the pixels included in the captured image.

The acquisition section 131 also acquires information regarding the vehicle detected by the measurement section 142 and position and posture information regarding the vehicle detected by the posture estimation section 143. For example, the acquisition section 131 acquires IMU information as the position and posture information regarding the vehicle.

The acquisition section 131 may also acquire the position and posture information regarding the vehicle, on the basis of at least any of an operated amount of the brake pedal, accelerator pedal, or steering wheel of the vehicle; an amount of change in vehicle acceleration; or yaw rate information regarding the vehicle.

For example, the acquisition section 131 calculates and stores beforehand the relations between the control information regarding the vehicle (e.g., amounts of control of the brake pedal and accelerator pedal and amounts of change in acceleration and deceleration) and the position and posture information acquired in the case where the control information is generated. The relations allow the acquisition section 131 to associate the vehicle control information with the position and posture information regarding the vehicle. In such a case, the acquisition section 131 can obtain the position and posture information regarding the vehicle that is calculated on the basis of the vehicle control information. This enables the acquisition section 131 to provide information that can be used by the object recognition section 132 in performing the process of tracking the second regions, for example.

Also, the acquisition section 131 may acquire various types of information on the basis of visible light communication. For example, the acquisition section 131 may acquire, through vehicle-to-vehicle communication with a vehicle ahead, a moving speed of the vehicle ahead and a predicted time to collision with the vehicle ahead based on the moving speed. The acquisition section 131 may also acquire the moving speed of the light sources with which visible light communication is performed. For example, in a case where the tail lights of the vehicle ahead are the light sources with which visible light communication is conducted, the acquisition section 131 can acquire the moving speed of the light sources by obtaining the moving speed of the vehicle ahead.

The acquisition section 131 stores the acquired information into the storage section 120, as needed. The acquisition section 131 may also obtain, from the storage section 120, the information necessary for processing, as needed. The acquisition section 131 may further acquire the information required for processing, by way of the detection section 140 and the input section 150. The acquisition section 131 may also acquire the information from an external apparatus via the network N.

The object recognition section 132 detects objects by performing an image recognition process on the image acquired by the acquisition section 131. As depicted in FIG. 2, the object recognition section 132 includes a first extraction section 133 and a second extraction section 134.

The first extraction section 133 detects an object included in the image and extracts a first region that includes the object. For example, the first extraction section 133 detects, as an object, at least any of a vehicle, a bicycle, traffic lights, or road studs. The second extraction section 134 detects light sources in the first region and extracts therefrom second regions that include the light sources.

The object recognition section 132 (first extraction section 133 and second extraction section 134) also performs the process of keeping track of (tracking) the extracted regions. Thus, even in a case where the detected light sources or the visible light communication apparatus 100 itself has moved, the object recognition section 132 still enables visible light communication to be continued.

The tracking process performed by the object recognition section 132 is explained below with reference to FIGS. 3 to 6. FIG. 3 is a diagram (1) for explaining the object recognition process according to the embodiment of the present disclosure.

The example illustrated in FIG. 3 indicates a state in which the vehicle on which the visible light communication apparatus 100 is mounted is traveling on an inclined road. An image 20 in the example is captured by the visible light communication apparatus 100 while the vehicle is traveling on the inclined road.

After acquiring the image 20, the object recognition section 132 extracts a first region 22 that includes the vehicle ahead. The object recognition section 132 also detects light sources included in the first region 22 and extracts second regions 24 and 26 including the light sources.

Thereafter, as the visible light communication apparatus 100 continues to travel, the inclination of the road is assumed to be changed (step S11). In such a case, the visible light communication apparatus 100 acquires a captured image 28. In the image 28, the first region 22 including the same vehicle ahead as well as the second regions 24 and 26 are expected to be shifted from their positions in the image 20.

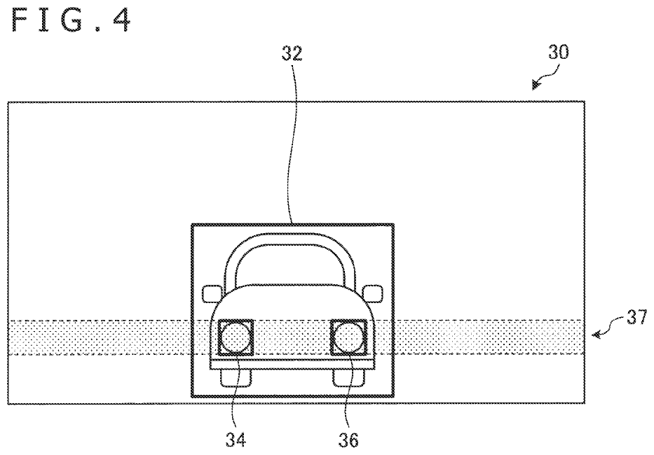

In such a case, the object recognition section 132 continuously performs visible light communication by tracing the positions of the extracted regions by using techniques explained below with reference to FIG. 4 and other drawings.

For example, the object recognition section 132 tracks the second region 24 and other regions on the basis of line-by-line luminance values at the time when the CMOS image sensor reads an image. This point is explained with reference to FIG. 4. FIG. 4 is a diagram (2) for explaining the object recognition process according to the embodiment of the present disclosure.

An image 30 depicted in FIG. 4 is acquired by the visible light communication apparatus 100 at a predetermined timing. The image 30 includes a first region 32 and second regions 34 and 36. As described above, the object recognition section 132 performs readout processing on the second regions 34 and 36 through RoI processing. Generally, the readout processing is carried out on the lines that include the second regions 34 and 36 and that are in parallel with the image 30. Specifically, in the example in FIG. 4, the object recognition section 132 performs readout processing on the lines corresponding to a region 37 that includes the second regions 34 and 36.

Then, on the basis of the luminance value information obtained by readout of the region 37, the object recognition section 132 determines a transition of the second region 34 and other regions to track these regions (i.e., of the light sources with which visible light communication is performed).

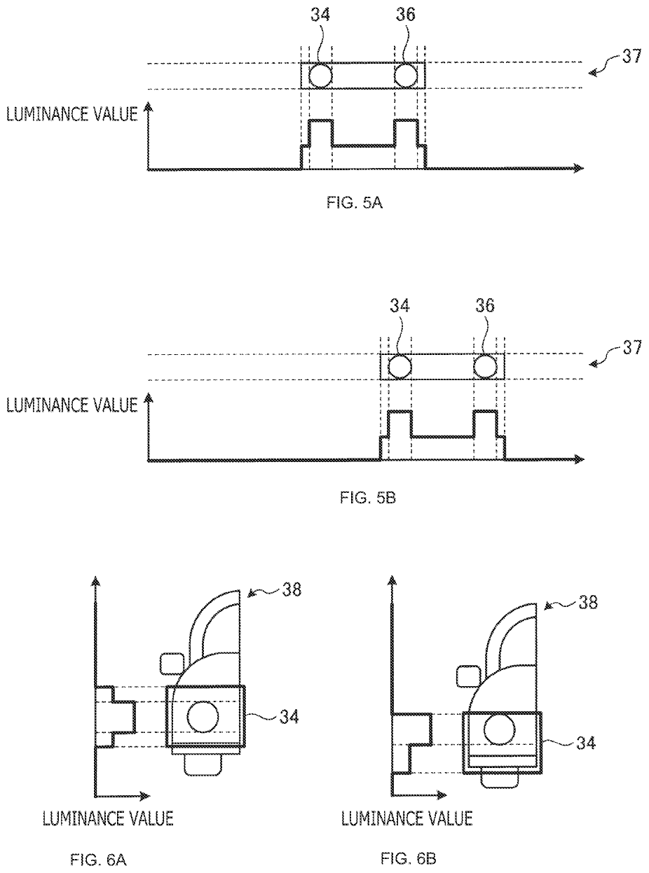

This point is explained with reference to FIG. 5. FIG. 5 depicts diagrams (3) for explaining the object recognition process according to the embodiment of the present disclosure. The example in FIG. 5 indicates a state in which the behavior of the vehicle on which the visible light communication apparatus 100 is mounted has caused a lateral shift with respect to FIG. 30.

In such a case, the object recognition section 132 acquires the luminance values of the second regions 34 and 36 in the lines corresponding to the region 37. For example, as depicted in FIG. 5(a), the luminance values corresponding to the light sources in the second regions 34 and 36 in the image 30 are expected to be relatively higher than the luminance values of the surroundings when being detected.

Thereafter, a lateral shift is assumed to have occurred with respect to the image 30 due to the behavior of the vehicle on which the visible light communication apparatus 100 is mounted or due to the movement of the vehicle ahead. Such a situation is illustrated in FIG. 5(b).

In FIG. 5(b), the object recognition section 132 also acquires the luminance values of the second regions 34 and 36 in the line which corresponds to the region 37. For example, as depicted in FIG. 5(b), the luminance values corresponding to the light sources in the second regions 34 and 36 in the image 30 are expected to be relatively higher than the luminance values of the surroundings when being detected.

In a case where the luminance values are acquired as described above, the luminance values of the regions including the light sources, such as the second regions 34 and 36, are expected to have a characteristic shape, as indicated by luminance value graphs in FIG. 5(a) and FIG. 5(b). By detecting such characteristics of the luminance values, the object recognition section 132 can track the second region 34 and other regions.

Incidentally, the luminance values may be either absolute values in the image 30 or differences in luminance values between the target image 30 to be processed and the immediately preceding frame. For example, the object recognition section 132 may acquire differences in luminance values between the immediately preceding frame and the target image 30 to be processed and search for the position where the acquired luminance differences are minimal, thereby tracking the second region 34 and other regions.

In view of the above-described process of acquiring luminance values, the object recognition section 132 may extract the second region in such a manner as to circumscribe the light source with a margin area not excluded but included to a certain extent. For example, the object recognition section 132 may determine the margin area for the second region on the basis of the following mathematical formula (1).

$$[ Math . 1 ]$$

$$p = C \frac{v}{f} \qquad ( 1 )$$

In the above mathematical formula (1), p denotes a margin size (e.g., number of pixels), and v represents the moving speed of the light source. Further, f denotes the frame rate of the multiple images used for processing (i.e., moving image), and C represents a predetermined constant. The object recognition section 132 may use the above mathematical formula (1) to provide a predetermined margin in the second region, thereby improving the accuracy of the tracking process such as one illustrated in FIG. 5. It should be noted that the moving speed of the light source can be acquired, for example, by visible light communication between the vehicle ahead and the visible light communication apparatus 100 (vehicle-to-vehicle communication) and by use of predetermined distance measurement techniques.

Next, a state in which a longitudinal shift relative to the image 30 is caused by the behavior of the vehicle on which the visible light communication apparatus 100 is mounted is explained. FIG. 6 depicts diagrams (4) for explaining the object recognition process according to the embodiment of the present disclosure. The example in FIG. 6 indicates the state in which a longitudinal shift relative to the image 30 is brought about by the behavior of the vehicle on which the visible light communication apparatus 100 is mounted.

In the example depicted in FIG. 6(a), the visible light communication apparatus 100 detects a vehicle ahead 38 and extracts the second region 34. In such a case, the luminance value graph in the image has the shape indicated in FIG. 6(a) because the position of the light source (tail light of the vehicle ahead 38 in the example) is elevated.

Suppose now that the behavior of the vehicle on which the visible light communication apparatus 100 is mounted or the movement of the vehicle ahead 38 has caused the second region 34 to develop a longitudinal shift relative to the image 30. Such a situation is illustrated in FIG. 6(b).

In FIG. 6(b), the object recognition section 132 acquires the luminance value of the second region 34. For example, as depicted in FIG. 6(b), the luminance value corresponding to the second region 34 produces a longitudinal shift while maintaining the shape illustrated in FIG. 6(a). The object recognition section 132 can track the second region 34 by detecting such a longitudinal shift of the luminance value (more specifically, the longitudinal shift of the graph corresponding to the luminance value).

As explained above with reference to FIGS. 3 to 6, the object recognition section 132 detects the light source on the basis of the luminance values of the pixels included in the first region, and detects the regions circumscribing the detected light sources as the second regions.

On the basis of the moving speed of the light source, for example, the object recognition section 132 further determines a range of the regions to be detected as the second regions. On the basis of the frame rate at the time of processing the image captured by the sensor, for example, the object recognition section 132 determines the range of the regions to be detected as the second regions.

As described above, the object recognition section 132 can accurately track the second regions by determining the range (i.e., margin areas) of the second regions on the basis of the information for use in visible light communication processing (i.e., moving speed of the light sources and frame rate). The object recognition section 132 thus enables visible light communication in a stable manner.

Referring back to FIG. 2, the description continues below. The visible light communication section 135 performs visible light communication with a predetermined target on the basis of the blinking of the light sources. Specifically, the visible light communication section 135 conducts visible light communication with the light sources included in the second regions extracted by the second extraction section 134.

The visible light communication section 135 includes an exposure control section 136 and a decoding section 137. The exposure control section 136 controls an exposure time at the time of capturing an image. As will be described later in detail, there are cases where the amount of information in visible light communication varies with the exposure time. The decoding section 137 decodes digital data acquired by visible light communication. For example, the decoding section 137 decodes the acquired digital data into specific information such as the moving speed of the vehicle ahead, information regarding an accident ahead, and congestion information.

The visible light communication section 135 performs visible light communication by tracking the transition of the second regions among multiple images acquired by the acquisition section 131. Specifically, the visible light communication section 135 recognizes the second regions tracked by the object recognition section 132 and conducts visible light communication with the light sources included in the second regions.

For example, the visible light communication section 135 performs visible light communication by tracking the second regions on the basis of the position and posture information regarding the vehicle on which the visible light communication apparatus 100 is mounted. That is, the visible light communication section 135 tracks the second regions by correcting their shift among images on the basis of the position and posture information such as IMU information, thereby making it possible to continue visible light communication with the light sources included in the second regions.

Also, the visible light communication section 135 may perform visible light communication by tracking the second regions on the basis of luminance values. That is, as depicted in FIGS. 5 and 6, the visible light communication section 135 tracks the second regions by correcting their shift on the basis of the differences in luminance values among images, thus making it possible to continue visible light communication with the light sources included in the second regions.

As described above, the visible light communication section 135 performs visible light communication by selecting only the second regions from the image acquired by the acquisition section 131, as the target for visible light readout. This eliminates the need for the visible light communication section 135 to read the entire image and thus enables the visible light communication section 135 to perform high-speed readout.

Alternatively, the visible light communication section 135 may conduct visible light communication by sampling the blinking of the light source for each of the lines included in the sensor. For example, in a case where the CMOS image sensor reads images, the visible light communication section 135 performs the sampling per line in keeping with the line scan for image readout. As a result, visible light communication can be performed at a sampling rate higher than usual, enabling the visible light communication section 135 to perform visible light communication with larger amounts of information.

### [1-3. Information Processing Procedure According to Embodiment]

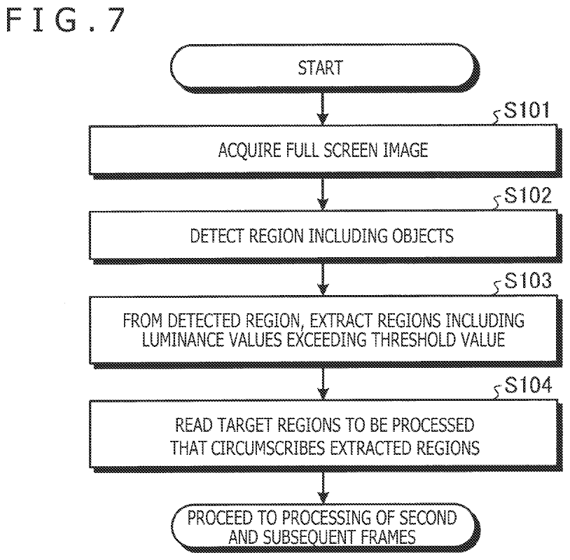

An information processing procedure according to the embodiment is next explained with reference to FIGS. 7 to 9. FIG. 7 is a flowchart (1) depicting a process flow according to the embodiment of the present disclosure. FIG. 7 indicates a flow of steps for acquiring a first image (frame) in a case where visible light communication processing is performed according to the present disclosure.

As depicted in FIG. 7, the visible light communication apparatus 100 acquires a full-screen image by means of the sensor such as a camera (step S101). From the acquired full-screen image, the visible light communication apparatus 100 detects a region (first region) that includes objects (step S102).

From the detected region, the visible light communication apparatus 100 extracts regions (light sources) that include luminance values exceeding a threshold value (step S103).

The visible light communication apparatus 100 further reads target regions to be processed (second regions) that circumscribe the extracted regions (step S104). Thereafter, the visible light communication processing according to the present disclosure proceeds to processing of a second and subsequent frames.

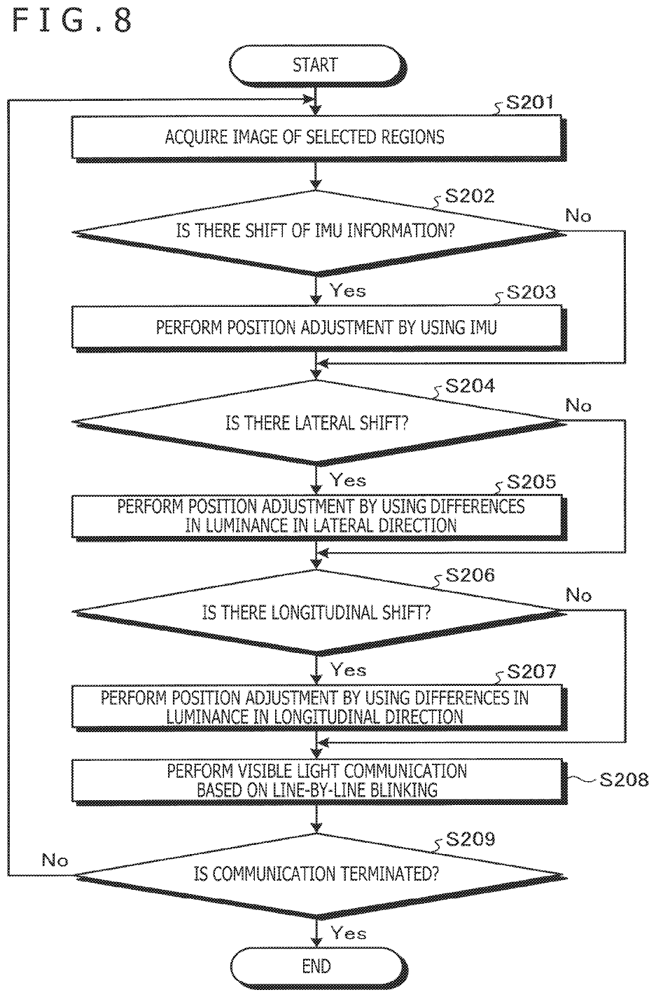

Processing continued from the processing depicted in FIG. 7 is next explained with reference to FIG. 8. FIG. 8 is a flowchart (2) depicting a process flow according to the embodiment of the present disclosure.

As depicted in FIG. 8, the visible light communication apparatus 100 acquires an image of the selected regions (second regions) (step S201). The visible light communication apparatus 100 then determines whether or not there is a shift of IMU information with respect to the vehicle on which the own apparatus is mounted (step S202).

In a case where there is a shift of IMU information (step S202: Yes), the visible light communication apparatus 100 performs position adjustment by using the IMU (step S203).

In a case where there is no shift of IMU information (step S202: No), the visible light communication apparatus 100 determines whether or not there is a shift of the second regions in the lateral direction between the image acquired in step S201 and the image of the immediately preceding frame (step S204).

In a case where there is a lateral shift (step S204: Yes), the visible light communication apparatus 100 performs position adjustment by using the differences in luminance values in the lateral direction (step S205).

In a case where there is no shift in the lateral direction (step S204: No), the visible light communication apparatus 100 determines whether or not there is a shift of the second regions in the longitudinal direction between the image acquired in step S201 and the image of the immediately preceding frame (step S206).

In a case where there is a longitudinal shift (step S206: YES), the visible light communication apparatus 100 performs position adjustment by using the differences in luminance values in the longitudinal direction (step S207).

Thereafter, the visible light communication apparatus 100 conducts visible light communication based on the blinking per line of the image sensor (step S208).

The visible light communication apparatus 100 then determines whether or not communication is terminated, prior to acquisition of the next image, for example (step S209). In a case where visible light communication is terminated (step S209: Yes), the visible light communication apparatus 100 terminates the processing. On the other hand, in a case where visible light communication is not terminated (step S209: No), the visible light communication apparatus 100 repeats the step of acquiring the image of the next frame (step S201).

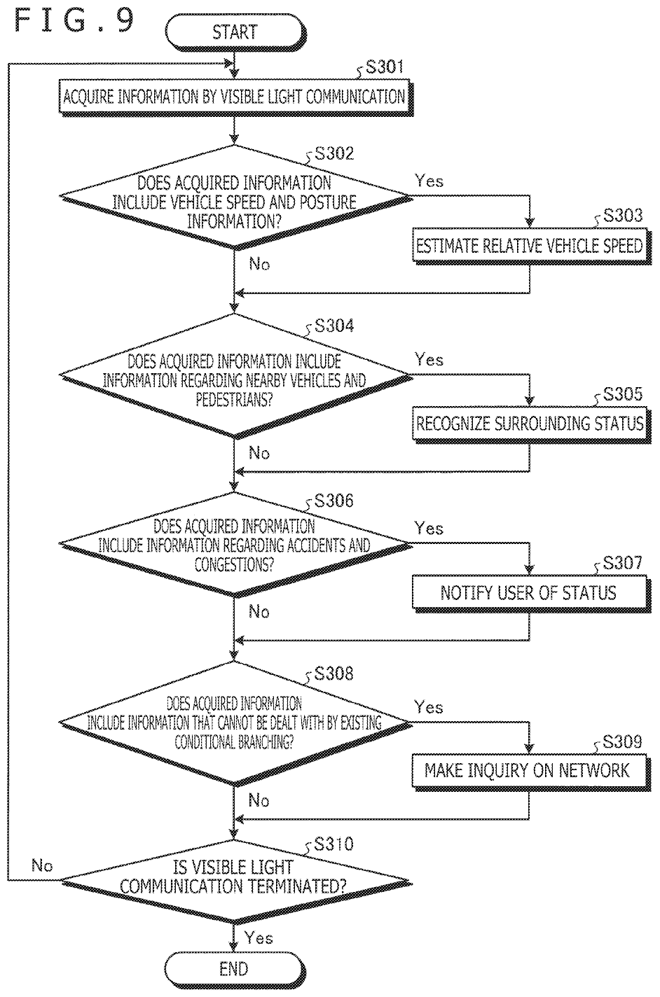

Next, a specific example of the process flow in the middle of visible light communication is explained with reference to FIG. 9. FIG. 9 is a flowchart (3) depicting a process flow according to the embodiment of the present disclosure.

As depicted in FIG. 9, the visible light communication apparatus 100 acquires information by visible light communication (step S301). The visible light communication apparatus 100 determines whether or not the acquired information includes a vehicle speed and posture information (step S302). In a case where the acquired information includes the vehicle speed and the posture information (step S302: Yes), the visible light communication apparatus 100 estimates a relative vehicle speed (step S303), for example. This enables the vehicle on which the visible light communication apparatus 100 is mounted, to predict a collision with the vehicle ahead, for example.

In a case where the acquired information does not include the vehicle speed and the posture information (step S302: No), the visible light communication apparatus 100 determines whether or not the acquired information includes information regarding nearby vehicles or pedestrians (step S304), for example. In a case where the acquired information includes the information regarding nearby vehicles or pedestrians (step S304: Yes), the visible light communication apparatus 100 recognizes the surrounding status (step S305). This enables the vehicle on which the visible light communication apparatus 100 is mounted, to take actions such as execution of a process of avoiding collisions with any nearby vehicle or pedestrian or execution of a change of the direction in which the own vehicle is traveling.

In a case where the acquired information does not include the information regarding nearby vehicles or pedestrians (step S304: No), the visible light communication apparatus 100 determines whether or not the acquired information includes information regarding accidents or congestions (step S306). In a case where the acquired information includes the information regarding accidents or congestions (step S306: Yes), the visible light communication apparatus 100 notifies the user of the status by using a display and speakers (step S307), for example. This enables the vehicle on which the visible light communication apparatus 100 is mounted, to notify the user of the information regarding any accident or congestion before an encounter therewith.

In a case where the acquired information does not include the information regarding accidents or congestions (step S306: No), the visible light communication apparatus 100 determines whether or not the acquired information includes information that cannot be dealt with by existing conditional branching (step S308). In a case where the acquired information includes any information that cannot be addressed by the existing conditional branching (step S309: Yes), the visible light communication apparatus 100 inquires servers on the network, for example, about actions that can be taken by the own apparatus.

On the other hand, in a case where the acquired information does not include any information that cannot be dealt with by the existing conditional branching (step S308: No), the visible light communication apparatus 100 determines that a relevant series of actions have been completed on the information acquired by visible light communication. The visible light communication apparatus 100 then determines whether or not visible light communication is terminated (step S310). If visible light communication is terminated (step S310: Yes), the visible light communication apparatus 100 terminates the processing related to visible light communication. If visible light communication is not terminated (step S310: No), the visible light communication apparatus 100 continues the step of acquiring information by visible light communication (step S301).

### 2. Other Embodiments

The above-described processes according to the embodiments may also be implemented in various ways different from how the above embodiments proceed with the processes.

[2-1. Different Processes with Different Number of Cameras]

In the above-mentioned embodiment, it has been explained that the camera on which the visible light communication apparatus 100 is mounted may be either a monocular camera or a stereo camera (multiple cameras). In a case where the visible light communication apparatus 100 is equipped with the stereo camera, the visible light communication apparatus 100 can perform ordinary ADAS image recognition processing with one camera, and conduct RoI processing and visible light communication with another camera.

In such a case, the visible light communication apparatus 100 detects objects and light sources from a first-frame image acquired by one camera for ordinary ADAS processing, and transfers the detected information to the other camera. On the basis of the acquired information, the visible light communication apparatus 100 carries out RoI processing and visible light communication by using the other camera.

In such a manner, when being equipped with multiple cameras, the visible light communication apparatus 100 can execute ordinary ADAS image acquisition by using one camera and the acquisition of images for visible light communication by using another camera. This enables the visible light communication apparatus 100 to perform high-speed communication continuously.

In a case of performing the visible light communication processing according to the present disclosure by using the monocular camera, the visible light communication apparatus 100 carries out alternately the acquisition of images for object detection and for image recognition and the acquisition of images for visible light communication.

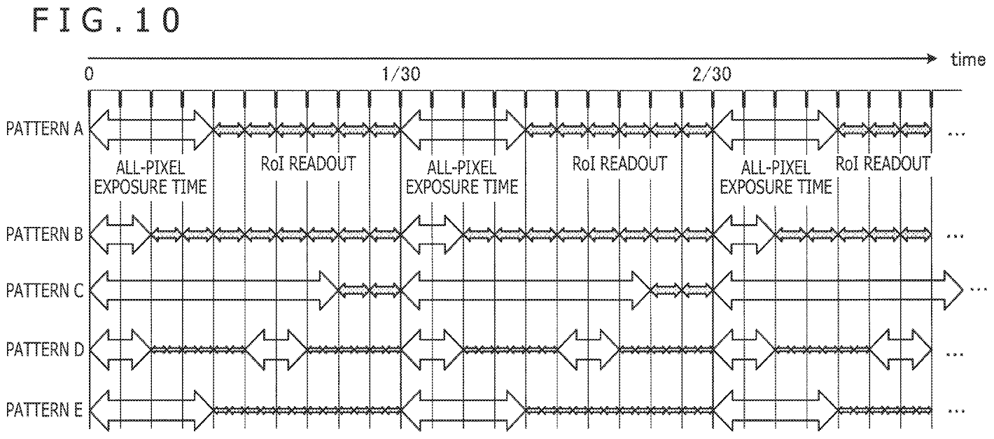

This point is explained with reference to FIG. 10. FIG. 10 is a diagram for explaining visible light communication processing according to a modification of the present disclosure.

FIG. 10 depicts typical relations between exposure time and RoI readout processing time in the case where the monocular camera is used to perform alternately the acquisition of images for object detection and for image recognition and the acquisition of images for visible light communication.

That is, because the monocular camera is used to perform alternately the acquisition of images at a given frame rate (30 fps (frames per second) in the example of FIG. 10) and RoI readout (visible light communication), the period of time until the monocular camera acquires one frame is divided into periods of time for exposure and RoI readout.

For example, pattern A illustrated in FIG. 10 is assumed to represent an example of reference settings of exposure time and RoI readout count. That is, the pattern A indicates that the visible light communication apparatus 100 spends 40 percent of one-thirtieth second on exposure and the remaining 60 percent on RoI readout repetitively.

Pattern B indicates that the visible light communication apparatus 100 spends 20 percent of one-thirtieth second on exposure and the remaining 80 percent on RoI readout repetitively. The pattern B is applied to time slots in which external light is abundant, such as the daytime. That is, since a shorter-than-usual all-pixel exposure time is sufficient in the daytime, RoI readout can be performed for longer time.

Pattern C indicates that the visible light communication apparatus 100 spends 80 percent of one-thirtieth second on exposure and the remaining 20 percent on RoI readout repetitively. The pattern C is applied to time slots such as the nighttime. That is, since a longer-than-usual all-pixel exposure time is required in the nighttime, RoI readout is reduced.

Pattern D indicates that the visible light communication apparatus 100 has raised the frame rate, spending 40 percent of one-sixtieth second on exposure and the remaining 60 percent on RoI readout. That is, the visible light communication apparatus 100 handles the rise in the frame rate by increasing the number of cycles per unit time. In the pattern D, the time required for RoI readout is half the time in the patterns A to C, as depicted in FIG. 10.

Incidentally, as indicated by pattern E, while the cycles of exposure time and RoI readout are maintained, the visible light communication apparatus 100 may increase solely the number of times at which RoI readout is performed.

In such a manner, the visible light communication apparatus 100 using the monocular camera can still perform the information processing according to the present disclosure. This enables the visible light communication apparatus 100 to conduct stable visible light communication while reducing the cost of installing cameras.

### [2-2. Transmission/Reception Process in Visible Light Communication]

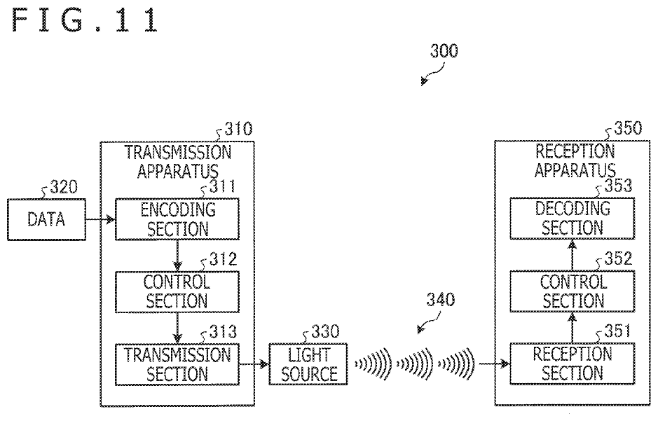

A transmission/reception process in the visible light communication processing according to the present disclosure is explained below with reference to FIG. 11. FIG. 11 is a diagram for explaining a transmission/reception process in visible light communication.

As depicted in FIG. 11, a visible light communication system 300 includes a transmission apparatus 310, a light source 330, and a reception apparatus 350. In one embodiment, the transmission apparatus 310 corresponds to, for example, the vehicle ahead 38. In the embodiment, the light source 330 corresponds to, for example, the tail lights or the brake lights of the vehicle ahead 38. In the embodiment, the reception apparatus 350 corresponds to the visible light communication apparatus 100 in the embodiment.

Upon receipt of data 320, the transmission apparatus 310 causes an encoding section 311 to encode the received data. The transmission apparatus 310 subsequentially causes a control section 312 to convert the encoded data into a predetermined format. Then, the transmission apparatus 310 causes a transmission section 313 to transmit the converted data to the light source 330.

The light source 330 transmits visible light 340 to the reception apparatus 350 by blinking a predetermined number of times set in advance, per unit time. It should be noted that, for data transmission, the light source 330 may use, for example, a carousel transmission system to further improve the stability of communication.

The reception apparatus 350 causes a reception section 351 to receive the visible light 340. The reception apparatus 350 subsequentially causes a control section 352 to convert the received data into a predetermined format. Then, the reception apparatus 350 causes a decoding section 353 to decode the converted data, thereby acquiring the data 320 transmitted from the transmission apparatus 310.

### [2-3. Configuration of Mobile Object]

In the example of the above-described embodiment, the visible light communication apparatus 100 is mounted on the mobile object. Alternatively, the visible light communication apparatus 100 may be implemented by an autonomous mobile object itself which performs automated driving (i.e., vehicle). In such a case, in addition to the configuration depicted in FIG. 2, the visible light communication apparatus 100 may have the configuration described below. It should be noted that components to be described below may also be included, for example, in the configuration depicted in FIG. 2.

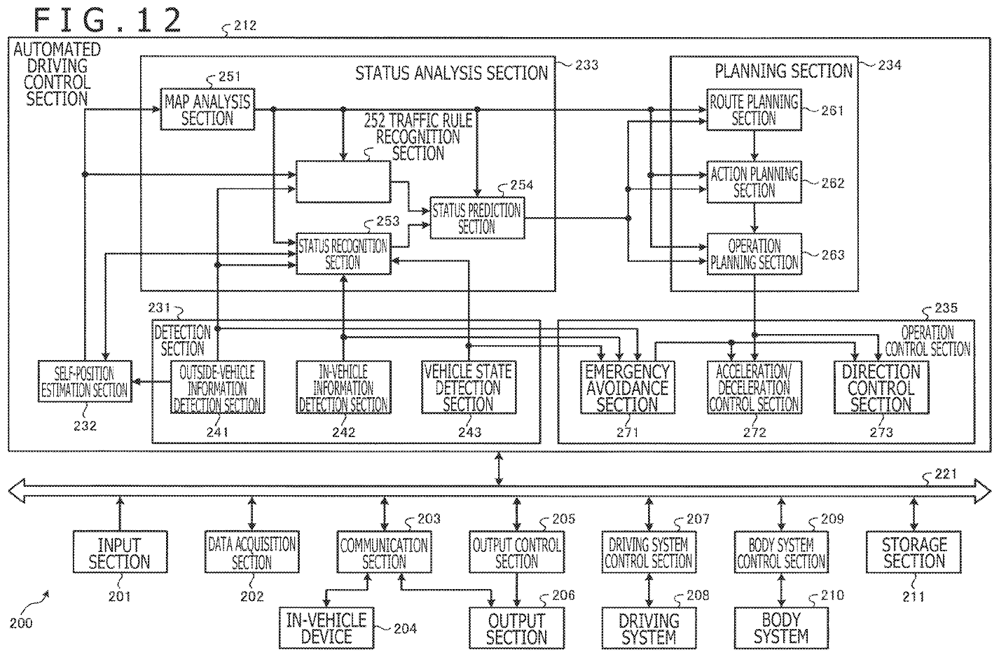

Specifically, the visible light communication apparatus 100 according to the present disclosure can also be configured as a mobile object control system to be described below. FIG. 12 is a block diagram depicting a schematic functional configuration example of the mobile object control system to which the present technology is applicable.

In a vehicle control system 200 as an example of the mobile body control system, an automated driving control section 212 corresponds to the control section 130 of the visible light communication apparatus 100 according to the embodiment. A detection section 231 and a self-position estimation section 232 of the automated driving control section 212 correspond to the detection section 140 of the visible light communication apparatus 100 according to the embodiment. A status analysis section 233 of the automated driving control section 212 corresponds to the acquisition section 131 and the object recognition section 132 of the control section 130. A planning section 234 of the automated driving control section 212 corresponds to the object recognition section 132 and the visible light communication section 135 of the control section 130. An operation control section 235 of the automated driving control section 212 corresponds to the object recognition section 132 and the visible light communication section 135 of the control section 130. The automated driving control section 212 may further include blocks corresponding to the processing sections of the control section 130, in addition to the blocks depicted in FIG. 12.

It should be noted that, in the following description, the vehicle on which the vehicle control system 200 is mounted will be referred to as the own vehicle in a case of being distinguished from other vehicles.

The vehicle control system 200 includes an input section 201, a data acquisition section 202, a communication section 203, in-vehicle devices 204, an output control section 205, an output section 206, a driving system control section 207, a driving system 208, a body system control section 209, a body system 210, a storage section 211, and the automated driving control section 212. The input section 201, the data acquisition section 202, the communication section 203, the output control section 205, the driving system control section 207, the body system control section 209, the storage section 211, and the automated driving control section 212 are interconnected via a communication network 221. The communication network 221 includes, for example, an onboard communication network and buses based on appropriate standards such as the CAN (Controller Area Network), the LIN (Local Interconnect Network), a LAN (Local Area Network), or FlexRay (registered trademark) standards. It is to be noted that the respective components of the vehicle control system 200 may directly be connected with one another without intervention of the communication network 221.

It should be noted that, in the following description, in a case where the respective components of the vehicle control system 200 communicate with one another via the communication network 221, the reference to the communication network 221 will be omitted. For example, in a case where the input section 201 and the automated driving control section 212 communicate with each other via the communication network 221, it will be stated simply that the input section 201 and the automated driving control section 212 communicate with each other.

The input section 201 includes equipment used by a passenger to input various kinds of data and instructions. For example, the input section 201 includes operation devices such as a touch panel, buttons, a microphone, switches, and levers, as well as an operation device to which input can be made by use of voice, gestures, or the like without manual entry. Alternatively, the input section 201 may be, for example, an externally connected device such as a remote control device using infrared rays or other radio waves or a mobile or wearable device corresponding to the operations of the vehicle control system 200. The input section 201 generates input signals on the basis of the data and instructions input by the passenger, and supplies the generated signals to the respective components of the vehicle control system 200.

The data acquisition section 202 includes, for example, various sensors for acquiring the data to be used by the vehicle control system 200 for processing. The data acquisition section 202 supplies the acquired data to the respective components of the vehicle control system 200.

For example, the data acquisition section 202 includes various sensors for detecting the state of the own vehicle. Specifically, the data acquisition section 202 may include a gyro sensor, an acceleration sensor, an inertial measurement unit (IMU), and a sensor for detecting an operated amount of the accelerator pedal, an operated amount of the brake pedal, a steering angle of the steering wheel, an engine speed, a motor rotation speed, or a wheel rotation speed, for example.

The data acquisition section 202 further includes various sensors for detecting, for example, information regarding the outside of the own vehicle. Specifically, the data acquisition section 202 includes, for example, an imaging device such as a ToF (Time of Flight) camera, a stereo camera, a monocular camera, an infrared camera, or other cameras. The data acquisition section 202 also includes, for example, an environment sensor for detecting the weather or the climate and a surrounding information detection sensor for detecting objects in the surroundings of the own vehicle. The environment sensor includes, for example, a raindrop sensor, a fog sensor, a sunshine sensor, and a snow sensor. The surrounding information detection sensor is configured with an ultrasonic sensor, radar, LiDAR (Light Detection and Ranging, Laser Imaging Detection and Ranging), and a sonar, for example.

The data acquisition section 202 further includes, for example, various sensors for detecting the current position of the own vehicle. Specifically, the data acquisition section 202 includes a GNSS (Global Navigation Satellite System) receiver for receiving GNSS signals from GNSS satellites, for example.

The data acquisition section 202 further includes various sensors for detecting, for example, in-vehicle information. Specifically, the data acquisition section 202 includes, for example, an imaging device for capturing images of the driver, a biosensor for detecting biological information regarding the driver, and a microphone for collecting sounds in the vehicle. The biosensor may be attached to the driver's seat or to the steering wheel to detect biological information regarding the driver sitting on the seat or gripping the steering wheel.

The communication section 203 communicates with the in-vehicle devices 204 and with various external devices, servers, and base stations. Thus, the communication section 203 transmits the data supplied from the respective components of the vehicle control system 200, to the communicating devices, and supplies the data received therefrom to the respective components of the vehicle control system 200. Incidentally, the communication protocol supported by the communication section 203 is not limited to anything specific. The communication section 203 can further support multiple communication protocols.

For example, the communication section 203 communicates with the in-vehicle devices 204 by a wireless LAN, Bluetooth (registered trademark), NFC (Near Field Communication), a WUSB (Wireless USB), or the like. As another example, the communication section 203 communicates with the in-vehicle devices 204 in a wired manner via a connection terminal (and via a cable, if necessary), which is not depicted, by using an USB (Universal Serial Bus), an HDMI (High-Definition Multimedia Interface) (registered trademark), MHL (Mobile High-definition Link), or the like.

As another example, the communication section 203 communicates with devices (e.g., application servers or control servers) on external networks (e.g., the Internet, cloud networks, or proprietary networks of business operators) via a base station or an access point. As a further example, the communication section 203 communicates, by using a P2P (Peer To Peer) technology, with terminals near the own vehicle (e.g., terminals carried by pedestrians or set up in shops, or MTC (Machine Type Communication) terminals). As a still further example, the communication section 203 performs V2X communication including Vehicle to Vehicle communication, Vehicle to Infrastructure communication, Vehicle to Home communication, and Vehicle to Pedestrian communication. As an even further example, the communication section 203 includes a beacon receiver that receives radio waves or electromagnetic waves from wireless stations installed on the road, thereby acquiring information such as the current position, congestions, traffic regulations, or time to reach the destination.

The in-vehicle devices 204 include, for example, a mobile device or wearable device carried by the passenger, an information device brought onboard or attached to the own device, and a navigation device that searches for routes to desired destinations.

The output control section 205 controls output of various types of information to the passenger of the own vehicle or to the outside of the vehicle. For example, the output control section 205 generates an output signal that includes at least either visual information (e.g., image data) or audio information (e.g., sound data), and supplies the generated signal to the output section 206, thereby controlling the output section 206 to output the visual and audio information. Specifically, the output control section 205 generates a bird's-eye image or a panoramic image by combining the image data captured by different imaging devices of the data acquisition section 202, for example, and supplies an output signal including the generated image, to the output section 206. As another example, the output control section 205 generates sound data including a warning tone or a warning message against dangers such as a collision, a contact, or an entry into a hazardous zone, and supplies an output signal including the generated sound data, to the output section 206.

The output section 206 includes devices capable of outputting visual or audio information to the passenger of the own vehicle or to the outside thereof. For example, the output section 206 includes a display device, an instrument panel, audio speakers, headphones, a wearable device worn by the passenger such as a spectacle type display, a projector, and lights. Instead of an ordinary display-equipped device, the display device included in the output section 206 may be a device that displays visual information in the field of view of the driver, such as a head-up display, a transmissive display, or a device equipped with AR (Augmented Reality) display functions.

The driving system control section 207 generates various control signals and supplies the generated control signals to the driving system 208 to control the driving system 208. As needed, the driving system control section 207 supplies the control signals to the respective components other than the driving system 208, to notify them of the control state of the driving system 208.

The driving system 208 includes various devices related to the drive train of the own vehicle. For example, the driving system 208 includes a drive power generation device for generating drive power such as an internal combustion engine or drive motors, a drive power transmission mechanism for transmitting drive power to the wheels, a steering mechanism for adjusting the steering angle, a braking device for generating braking force, an ABS (Antilock Brake System), ESC (Electronic Stability Control), and an electric power steering device.

The body system control section 209 generates various control signals and supplies the generated control signals to the body system 210 to control the body system 210. As needed, the body system control section 209 supplies the control signals to the respective components other than the body system 210, to notify them of the control state of the body system 210.

The body system 210 includes various body-related devices mounted on the vehicle body. For example, the body system 210 includes a keyless entry system, a smart-key system, power window devices, power sheets, the steering wheel, an air-conditioner, and various lights (e.g., head lights, back lights, brake lights, turn signals, and fog lights).

The storage section 211 includes, for example, a magnetic storage device such as a ROM (Read Only Memory), a RAM (Random Access Memory) or an HDD (Hard Disc Drive), a semiconductor storage device, an optical storage device, and a magneto-optical storage device. The storage section 211 stores various types of programs and data for use by the respective components of the vehicle control system 200. For example, the storage section 211 stores map data representing three-dimensional high-precision maps such as dynamic maps, global maps having lower precision than that of the high-precision maps and covering a wide area, and local maps that include information regarding the surroundings of the own vehicle.

The automated driving control section 212 provides controls related to automated driving, such as autonomous traveling and driver assistance. Specifically, the automated driving control section 212 provides coordinated controls aimed at implementing functions such as collision avoidance or impact mitigation for the own vehicle; follow-on driving, cruising, and collision warning for the own vehicle based on inter-vehicle distance; or ADAS (Advanced Driver Assistance System) functions including a lane deviation warning for the own vehicle. As another example, the automated driving control section 212 provides coordinated controls aimed at automated driving for autonomous traveling without intervention of the driver. The automated driving control section 212 includes the detection section 231, the self-position estimation section 232, the status analysis section 233, the planning section 234, and the operation control section 235.

The detection section 231 detects various types of information necessary for automated driving control. The detection section 231 includes an outside-vehicle information detection section 241, an in-vehicle information detection section 242, and a vehicle state detection section 243.

The outside-vehicle information detection section 241 performs processes of detecting information regarding the outside of the own vehicle on the basis of the data or signals from the respective components of the vehicle control system 200. For example, the outside-vehicle information detection section 241 performs a process of detecting objects around the own vehicle, a process of recognizing the objects, a process of tracking the objects, and a process of detecting distances to the objects. The target objects to be detected include, for example, vehicles, pedestrians, obstacles, structures, roads, traffic lights, traffic signs, and road signs. As another example, the outside-vehicle information detection section 241 performs processes of detecting the surrounding environment of the own vehicle. The target surrounding environment to be detected includes, for example, weather, a temperature, humidity, brightness, and road surface conditions. The outside-vehicle information detection section 241 supplies data representing the result of the detection processes, to the self-position estimation section 232; to a map analysis section 251, a traffic rule recognition section 252, and a status recognition section 253 of the status analysis section 233; and to an emergency avoidance section 271 of the operation control section 235.

The in-vehicle information detection section 242 performs processes of detecting in-vehicle information on the basis of the data or signals from the respective components of the vehicle control system 200. For example, the in-vehicle information detection section 242 performs a process of authenticating and recognizing the driver, a process of detecting the state of the driver, a process of detecting passengers, and a process of detecting the in-vehicle environment. The target state of the driver to be detected includes, for example, physical conditions, a degree of vigilance, a degree of concentration, a degree of fatigue, and a line-of-sight direction. The target in-vehicle environment to be detected includes, for example, a temperature, humidity, brightness, and an odor. The in-vehicle information detection section 242 supplies data representing the result of the detection processes, to the status recognition section 253 of the status analysis section 233 and to the emergency avoidance section 271 of the operation control section 235.

The vehicle state detection section 243 performs processes of detecting the state of the own vehicle on the basis of the data or signals from the respective components of the vehicle control system 200. The target state of the own vehicle to be detected includes, for example, a speed, acceleration, a steering angle, presence or absence of an anomaly and its details, a state of driving operation, a position and inclination of the power sheet, a door lock state, and a state of other onboard devices. The vehicle state detection section 243 supplies data representing the result of the detection processes, to the status recognition section 253 of the status analysis section 233 and to the emergency avoidance section 271 of the operation control section 235.

The self-position estimation section 232 performs processes of estimating the position and posture of the own vehicle on the basis of the data or signals from the respective components of the vehicle control system 200, such as the outside-vehicle information detection section 241 and the status recognition section 253 of the status analysis section 233. As needed, the self-position estimation section 232 generates a local map for use in estimating the self-position of the own vehicle (the map will hereinafter be referred to as a self-position estimation map). The self-position estimation map may be a high-precision map that uses a SLAM (Simultaneous Location and Mapping) technology, for example. The self-position estimation section 232 supplies data representing the result of the estimation processes, to the map analysis section 251, the traffic rule recognition section 252, and the status recognition section 253 of the status analysis section 233. Further, the self-position estimation section 232 stores the self-position estimation map into the storage section 211.

The status analysis section 233 performs processes of analyzing the status of the own vehicle and the status of its surroundings. The status analysis section 233 includes the map analysis section 251, the traffic rule recognition section 252, the status recognition section 253, and a status prediction section 254.

The map analysis section 251 performs processes of analyzing various maps stored in the storage section 211, by using, as needed, the data or signals from the respective components of the vehicle control system 200, such as the self-position estimation section 232 and the outside-vehicle information detection section 241. Thus, the map analysis section 251 creates maps that include the information necessary for automated driving processing. The map analysis section 251 supplies the created maps to the traffic rule recognition section 252, the status recognition section 253, and the status prediction section 254, as well as to a route planning section 261, an action planning section 262, and an operation planning section 263 of the planning section 234.

The traffic rule recognition section 252 performs processes of recognizing the traffic rules around the own vehicle on the basis of the data or signals from the respective components of the vehicle control system 200, such as the self-position estimation section 232, the outside-vehicle information detection section 241, and the map analysis section 251. The recognition processes involve, for example, recognizing the positions and states of the traffic lights around the own vehicle, details of the traffic controls around the own vehicle, and the traffic lanes that can be traveled. The traffic rule recognition section 252 supplies data representing the result of the detection processes, to the status prediction section 254.

The status recognition section 253 performs processes of recognizing status related to the own vehicle on the basis of the data or signals from the respective components of the vehicle control system 200, such as the self-position estimation section 232, the outside-vehicle information detection section 241, the in-vehicle information detection section 242, the vehicle state detection section 243, and the map analysis section 251. For example, the status recognition section 253 performs processes of recognizing the status of the own vehicle, status of the surroundings of the own vehicle, and status of the driver of the own vehicle. As needed, the status recognition section 253 generates a local map for use in recognizing the status of the surroundings of the own vehicle (the map will hereinafter be referred to as a status recognition map). The status recognition map may be an Occupancy Grid Map, for example.

The target status of the own vehicle to be recognized includes, for example, the position, posture, and movement (e.g., speed, acceleration, and traveling direction) of the own vehicle, as well as the presence or absence of an anomaly and its details. The target status of the surroundings of the own vehicle to be recognized includes, for example, types and positions of nearby stationary objects; types, positions, and movements (e.g., speeds, acceleration, and traveling directions) of nearby moving objects; configurations and road surface conditions of nearby roads; and the weather, temperature, humidity, and brightness of the surroundings. The target state of the driver to be recognized includes, for example, physical conditions, a degree of vigilance, a degree of concentration, a degree of fatigue, a line-of-sight direction, and driving operation.

The status recognition section 253 supplies data representing the result of the recognition processes (including the status recognition map, as needed), to the self-position estimation section 232 and the status prediction section 254. Further, the status recognition section 253 stores the status recognition map into the storage section 211.

The status prediction section 254 performs processes of predicting the status related to the own vehicle on the basis of the data or signals from the respective components of the vehicle control system 200, such as the map analysis section 251, the traffic rule recognition section 252, and the status recognition section 253. For example, the status prediction section 254 performs processes of predicting the status of the own vehicle, the status of the surroundings of the own vehicle, and the status of the driver.

The target status of the own vehicle to be predicted includes, for example, the behavior of the own vehicle, occurrence of an onboard anomaly, and mileage of the own vehicle. The target status of the surroundings of the own vehicle to be predicted includes, for example, behaviors of moving objects, changes of the traffic lights, and environmental changes such as the weather around the own vehicle. The target status of the driver to be predicted includes, for example, the behavior and physical conditions of the driver.

The status prediction section 254 supplies data representing the result of the prediction processes, to the route planning section 261, the action planning section 262, and the operation planning section 263 of the planning section 234, together with the data from the traffic rule recognition section 252 and the status recognition section 253.

The route planning section 261 plans the route to the destination on the basis the data or signals from the respective components of the vehicle control system 200, such as the map analysis section 251 and the status prediction section 254. For example, on the basis of global maps, the route planning section 261 sets the route from the current position to a designated destination. Further, the route planning section 261 changes the route as needed on the basis of the status of congestions, accidents, traffic controls, and road repairing, as well as the physical conditions of the driver. The route planning section 261 supplies data representing the planned route, to the action planning section 262.

The action planning section 262 plans the action of the own vehicle for safely traveling within a planned time along the route planned by the route planning section 261, on the basis of the data or signals from the respective components of the vehicle control system 200, such as the map analysis section 251 and the status prediction section 254. For example, the action planning section 262 plans a start, a stop, advancing directions (e.g., moving forward, moving backward, left turn, right turn, or change of direction), traveling lanes, a traveling speed, and passing of another car. The action planning section 262 supplies data representing the planned action of the own vehicle, to the operation planning section 263.

The operation planning section 263 plans the operation of the own vehicle to implement the action planned by the action planning section 262, on the basis of the data or signals from the respective components of the vehicle control system 200, such as the map analysis section 251 and the status prediction section 254. For example, the operation planning section 263 plans acceleration, deceleration, and traveling tracks. The operation planning section 263 supplies data representing the planned operation of the own vehicle, to an acceleration/deceleration control section 272 and a direction control section 273 of the operation control section 235.

The operation control section 235 controls the operation of the own vehicle. The operation control section 235 includes the emergency avoidance section 271, the acceleration/deceleration control section 272, and the direction control section 273.

The emergency avoidance section 271 performs processes of detecting an emergency such as a collision, a contact, an entry into a hazardous zone, an anomaly of the driver, or an anomaly of the vehicle, on the basis of the result of the detection by the outside-vehicle information detection section 241, the in-vehicle information detection section 242, and the vehicle state detection section 243. In a case of detecting occurrence of an emergency, the emergency avoidance section 271 plans the operation of the own vehicle to avoid the emergency, such as a sudden stop or a sharp turn. The emergency avoidance section 271 supplies data representing the planned operation of the own vehicle, to the acceleration/deceleration control section 272 and the direction control section 273.

The acceleration/deceleration control section 272 performs acceleration/deceleration control to implement the operation of the own vehicle planned by the operation planning section 263 or by the emergency avoidance section 271. For example, the acceleration/deceleration control section 272 calculates a control target value for the drive power generation device or for the braking device such as to implement the planned acceleration, deceleration, or sudden stop. The acceleration/deceleration control section 272 supplies a control command indicative of the calculated control target value, to the driving system control section 207.

The direction control section 273 performs direction control to implement the operation of the own vehicle planned by the operation planning section 263 or by the emergency avoidance section 271. For example, the direction control section 273 calculates a control target value for the steering mechanism such as to implement the traveling track or a sharp turn planned by the operation planning section 263 or by the emergency avoidance section 271. The direction control section 273 supplies a control command indicative of the calculated control target value, to the driving system control section 207.

### [2-4. Others]

Of the processes explained above in connection with the embodiments, processes executed automatically may be performed manually in part or in total. As another alternative, the processes explained above as those performed manually may be executed automatically in part or in total by known methods. The processing procedures, specific names, and information including various types of data and parameters which are indicated in the foregoing description and in the accompanying drawings may be changed as needed unless otherwise specified. For example, the various types of information depicted in the respective drawings are not limitative of the present disclosure.

The constituent elements of the respective apparatuses in the drawings are functionally conceptual and need not necessarily be configured as illustrated physically. That is, specific forms of the respective apparatuses configured in a distributed or unified manner are not limited to the depicted forms and may, in part or in total, be configured in such a manner as to be functionally or physically distributed or unified in desired units depending on divers loads and use conditions.

The above-described embodiments and modifications can be combined as needed within a range not causing contradiction in processing details. Further, while the vehicle is used as an example of the mobile object in connection with the above embodiments, the information processing of the present disclosure may also be applied to mobile objects other than the vehicle. For example, the mobile object may be a small vehicle such as a motorcycle or a tricycle, a large vehicle such as a bus or a truck, or an autonomous mobile object such as a robot or a drone. Further, the visible light communication apparatus 100 need not necessarily be integral of the mobile object and may be, for example, a cloud server that acquires information from the mobile object over the network N and determines the range of elimination on the basis of the acquired information.

The advantageous effects stated in the present description are only examples and are not limitative of the present disclosure, and other advantageous effects may also be provided.

### 3. Effects of Visible Light Communication Apparatus According to Present Disclosure

As described above, the visible light communication apparatus according to the present disclosure (visible light communication apparatus 100 in the embodiment) includes the acquisition section (acquisition section 131 in the embodiment), the first extraction section (first extraction section 133 or object recognition section 132 in the embodiment), the second extraction section (second extraction section 134 or object recognition section 132 in the embodiment), and the visible light communication section (visible light communication section 135 in the embodiment). The acquisition section acquires an image captured by the sensor mounted on the mobile object. The first extraction section detects objects included in the image and extracts a first region that includes the detected objects. The second extraction section detects a light source from the first region and extracts a second region that includes the light source. The visible light communication section performs visible light communication with the light source included in the second region.

In such a manner, the visible light communication apparatus according to the present disclosure extracts objects from the image and performs visible light communication with the light source found in a region extracted from near the objects. As a result, the region from which the image to be used for communication is acquired can be minimized, and the visible light communication apparatus can thus improve the transmission speed of visible light communication. By extracting beforehand the target region to be processed, the visible light communication apparatus can improve the efficiency of visible light communication to perform stable visible communication for the mobile object.

The visible light communication section also performs visible light communication by tracking the transition of the second region among multiple images acquired by the acquisition section. This enables the visible light communication apparatus according to the present disclosure to prevent situations where the light source is lost sight of following movements. As a result, visible light communication is stably performed.

The acquisition section further acquires position and posture information regarding the mobile object. The visible light communication section performs visible light communication by tracking the second region on the basis of the position and posture information. This enables the visible light communication apparatus according to the present disclosure to track the light source accurately.

The acquisition section also acquires the position and posture information regarding the mobile object, on the basis of at least any of an operated amount of the brake pedal, accelerator pedal, or steering wheel of the mobile object; an amount of change in acceleration of the mobile object; or yaw rate information regarding the mobile object. This enables the visible light communication apparatus according to the present disclosure to track the light source and correct images on the basis of the various types of information. As a result, the stability of visible light communication is improved.

The acquisition section further acquires the luminance values of the pixels included in the second region. On the basis of the luminance values, the visible light communication section tracks the second region in performing visible light communication. This enables the visible light communication apparatus according to the present disclosure to track the light source accurately.

Further, the visible light communication section performs visible light communication by selecting the second region alone from the image, as the visible light readout target. This enables the visible light communication apparatus according to the present disclosure to minimize the processing region for use in visible light communication. As a result, the information processing related to visible light communication is performed at higher speed.

Further, the second extraction section detects a light source on the basis of the luminance values of the pixels included in the first region, and detects a region circumscribing the detected light source, as the second region. This enables the visible light communication apparatus according to the present disclosure to track not only the light source but also a region having a certain range. As a result, visible light communication is continued stably even in cases where the light source or the own apparatus has moved.

The acquisition section further acquires the moving speed of the light source. On the basis of the moving speed of the light source, the second extraction section determines the range to be detected as the second region. This enables the visible light communication apparatus according to the present disclosure to set, as the second region, the region optimally suited for the tracking according to the moving speed of the light source.

The second extraction section further determines the range of the region to be detected as the second region, on the basis of the frame rate for processing the images captured by the sensor. This enables the visible light communication apparatus according to the present disclosure to set, as the second region, the region optimally suited for the tracking according to the frame rate for the multiple images used in processing.

The visible light communication section further performs visible light communication by sampling the blinking of the light source for each of the lines included in the sensor. This enables the visible light communication apparatus according to the present disclosure to improve the sampling rate related to visible light communication. As a result, larger amounts of information can be received.

The acquisition section further acquires images captured by a monocular camera used as the sensor. The enables the visible light communication apparatus according to the present disclosure to conduct visible light communication stably while reducing the cost of setting up cameras.

The acquisition section further acquires images captured by a stereo camera used as the sensor. This enables the visible light communication apparatus according to the present disclosure to conduct visible light communication in a faster and more stable manner.

The first extraction section further detects, as an object, at least any of a vehicle, a bicycle, traffic lights, or road studs. This enables the visible light communication apparatus according to the present disclosure to preferentially detect an object which is assumed to send useful information to the mobile object.

### 4. Hardware Configuration

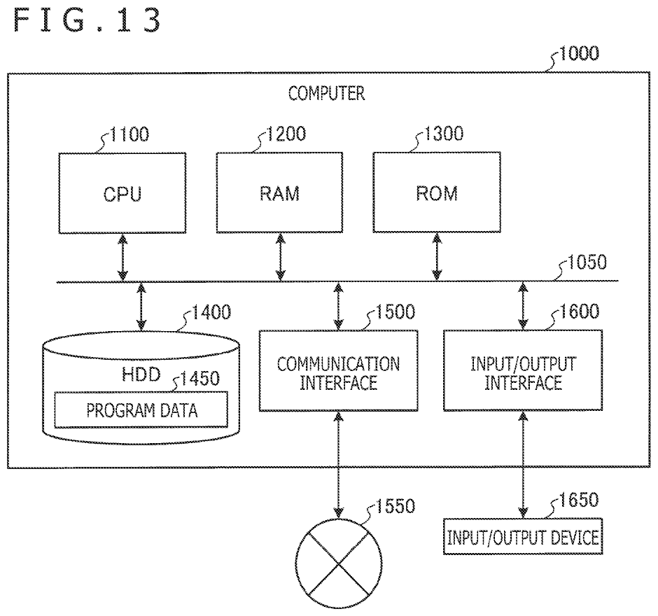

The information devices such as the visible light communication apparatus 100 according to the above-described embodiment are implemented by a computer 1000 configured as depicted in FIG. 13, for example. The following description is given by using the visible light communication apparatus 100 according to the embodiment as an example. FIG. 13 is a hardware configuration diagram depicting an example of the computer 1000 for implementing the functions of the visible light communication apparatus 100. The computer 1000 includes a CPU 1100, a RAM 1200, a ROM (Read Only Memory) 1300, an HDD (Hard Disk Drive) 1400, a communication interface 1500, and an input/output interface 1600. The components of the computer 1000 are interconnected via a bus 1050.

The CPU 1100 controls the components by operating according to programs stored in the ROM 1300 or on the HDD 1400. For example, the CPU 1100 loads programs from the ROM 1300 or from the HDD 1400 into the RAM 1200 to execute the processes corresponding to the loaded programs.

The ROM 1300 stores a bootstrap program such as a BIOS (Basic Input Output System) executed by the CPU 1100 at startup of the computer 1000, as well as programs dependent on the hardware of the computer 1000.

The HDD 1400 is a computer-readable recording medium that stores non-temporarily the programs for execution by the CPU 1100 as well as the data for use by such programs. Specifically, the HDD 1400 is a recording medium that records the visible light communication program according to the present disclosure which is an example of program data 1450.

The communication interface 1500 is an interface that connects the computer 1000 with an external network 1550 (e.g., the Internet). For example, the CPU 1100 receives data from other devices and transmits data generated by the CPU 1100 to other devices via the communication interface 1500.

The input/output interface 1600 is an interface that connects an input/output device 1650 with the computer 1000. For example, the CPU 1100 receives data from the input device such as a keyboard and a mouse via the input/output interface 1600. The CPU 1100 further transmits data to an output device such as a display, speakers, and a printer via the input/output interface 1600. Also, the input/output interface 1600 may function as a media interface for reading programs and other resources from predetermined recording media. The media include, for example, optical recording media such as a DVD (Digital Versatile Disc) and a PD (Phase change rewritable Disk), magneto-optical recording media such as an MO (Magneto-Optical disk), tape media, magnetic recording media, or semiconductor memories.

For example, in a case where the computer 1000 functions as the visible light communication apparatus 100 according to the embodiment, the CPU 1100 of the computer 1000 implements the functions of the control section 130 and other components by executing the visible light communication program loaded into the RAM 1200. Further, the HDD 1400 stores the visible light communication program according to the present disclosure and the data in the storage section 120. While the CPU 1100 reads and executes the program data 1450 following retrieval from the HDD 1400, the CPU 1100 may alternatively acquire such programs from other apparatuses via the external network 1550.

The present technology may also have the following configurations.
(1)

A visible light communication apparatus including:

an acquisition section configured to acquire an image captured by a sensor included in a mobile object;

a first extraction section configured to detect an object included in the image and extract a first region that includes the object;

a second extraction section configured to detect a light source from inside the first region and extract a second region that includes the light source; and

a visible light communication section configured to perform visible light communication with the light source included in the second region.
(2)

The visible light communication apparatus according to (1) above, in which

the visible light communication section performs the visible light communication by tracking a transition of the second region among multiple images acquired by the acquisition section.
(3)

The visible light communication apparatus according to (2) above, in which

the acquisition section acquires position and posture information regarding the mobile object, and

the visible light communication section performs the visible light communication by tracking the second region on the basis of the position and posture information.
(4)

The visible light communication apparatus according to (2) or (3) above, in which

the acquisition section acquires position and posture information regarding the mobile object, on the basis of at least any of an operated amount of a brake pedal, an accelerator pedal, or a steering wheel of the mobile object, an amount of change in acceleration of the mobile object, or yaw rate information regarding the mobile object.
(5)

The visible light communication apparatus according to any one of (2) to (4) above, in which

the acquisition section acquires a luminance value of a pixel included in the second region, and

the visible light communication section performs the visible light communication by tracking the second region on the basis of the luminance value.
(6)

The visible light communication apparatus according to any one of (1) to (5) above, in which

the visible light communication section performs the visible light communication by selecting, as a target for visible light readout, only the second region from the image.
(7)

The visible light communication apparatus according to any one of (1) to (6) above, in which

the second extraction section detects the light source on the basis of a luminance value of a pixel included in the first region, and detects a region circumscribing the detected light source, as the second region.
(8)

The visible light communication apparatus according to (7) above, in which

the acquisition section acquires a moving speed of the light source, and

the second extraction section determines a range of the region to be detected as the second region, on the basis of the moving speed of the light source.
(9)

The visible light communication apparatus according to (7) or (8) above, in which

the second extraction section determines a range of the region to be detected as the second region, on the basis of a frame rate for processing the image captured by the sensor.
(10)

The visible light communication apparatus according to any one of (1) to (9) above, in which

the visible light communication section performs the visible light communication by sampling blinking of the light source for each of lines included in the sensor.
(11) The visible light communication apparatus according to any one of (1) to (10) above, in which

the acquisition section acquires the imaqe captured by a monocular camera used as the sensor.
(12)

The visible light communication apparatus according to any one of (1) to (11) above, in which

the acquisition section acquires the image captured by a stereo camera used as the sensor.
(13)

The visible light communication apparatus according to any one of (1) to (12) above, in which

the first extraction section detects, as the object, at least any of a vehicle, a bicycle, traffic lights, or road studs.
(14)

A visible light communication method for causing a computer to perform:

acquiring an image captured by a sensor included in a mobile object;

detecting an object included in the image and extracting a first region that includes the object;

detecting a light source from inside the first region and extracting a second region that includes the light source; and

performing visible light communication with the light source included in the second region.
(15)

A visible light communication program causing a computer to function as:

an acquisition section configured to acquire an image captured by a sensor included in a mobile object;

a first extraction section configured to detect an object included in the image and extract a first region that includes the object;

a second extraction section configured to detect a light source from inside the first region and extract a second region that includes the light source; and

a visible light communication section configured to perform visible light communication with the light source included in the second region.

### REFERENCE SIGNS LIST

100: Visible light communication apparatus

110: Communication section

120: Storage section

130: Control section

131: Acquisition section

132: Object recognition section

133: First extraction section

134: Second extraction section

135: Visible light communication section

136: Exposure control section

137: Decoding section

140: Detection section

141: Imaging section

142: Measurement section

143: Posture estimation section

150: Input section

160: Output section

1. A visible light communication apparatus comprising:
an acquisition section configured to acquire an image captured by a sensor included in a mobile object;
a first extraction section configured to detect an object included in the image and extract a first region that includes the object;
a second extraction section configured to detect a light source from inside the first region and extract a second region that includes the light source; and
a visible light communication section configured to perform visible light communication with the light source included in the second region.

2. The visible light communication apparatus according to claim 1, wherein
the visible light communication section performs the visible light communication by tracking a transition of the second region among multiple images acquired by the acquisition section.

3. The visible light communication apparatus according to claim 2, wherein
the acquisition section acquires position and posture information regarding the mobile object, and
the visible light communication section performs the visible light communication by tracking the second region on a basis of the position and posture information.

4. The visible light communication apparatus according to claim 2, wherein
the acquisition section acquires position and posture information regarding the mobile object, on a basis of at least any of an operated amount of a brake pedal, an accelerator pedal, or a steering wheel of the mobile object, an amount of change in acceleration of the mobile object, or yaw rate information regarding the mobile object.

5. The visible light communication apparatus according to claim 2, wherein
the acquisition section acquires a luminance value of a pixel included in the second region, and
the visible light communication section performs the visible light communication by tracking the second region on a basis of the luminance value.

6. The visible light communication apparatus according to claim 1, wherein
the visible light communication section performs the visible light communication by selecting, as a target for visible light readout, only the second region from the image.

7. The visible light communication apparatus according to claim 1, wherein
the second extraction section detects the light source on a basis of a luminance value of a pixel included in the first region, and detects a region circumscribing the detected light source, as the second region.

8. The visible light communication apparatus according to claim 7, wherein
the acquisition section acquires a moving speed of the light source, and
the second extraction section determines a range of the region to be detected as the second region, on a basis of the moving speed of the light source.

9. The visible light communication apparatus according to claim 7, wherein
the second extraction section determines a range of the region to be detected as the second region, on a basis of a frame rate for processing the image captured by the sensor.

10. The visible light communication apparatus according to claim 1, wherein
the visible light communication section performs the visible light communication by sampling blinking of the light source for each of lines included in the sensor.

11. The visible light communication apparatus according to claim 1, wherein
the acquisition section acquires the image captured by a monocular camera used as the sensor.

12. The visible light communication apparatus according to claim 1, wherein
the acquisition section acquires the image captured by a stereo camera used as the sensor.

13. The visible light communication apparatus according to claim 1, wherein
the first extraction section detects, as the object, at least any of a vehicle, a bicycle, traffic lights, or road studs.

14. A visible light communication method for causing a computer to perform:
acquiring an image captured by a sensor included in a mobile object;
detecting an object included in the image and extracting a first region that includes the object;
detecting a light source from inside the first region and extracting a second region that includes the light source; and
performing visible light communication with the light source included in the second region.

15. A visible light communication program causing a computer to function as:
an acquisition section configured to acquire an image captured by a sensor included in a mobile object;
a first extraction section configured to detect an object included in the image and extract a first region that includes the object;
a second extraction section configured to detect a light source from inside the first region and extract a second region that includes the light source; and
a visible light communication section configured to perform visible light communication with the light source included in the second region.
